(19) United States
(12) Patent Application Publication
(10) Pub. No.: US 2025/0292561 A1
(43) Pub. Date: Sep. 18, 2025

(54) VIDEO PROCESSING SYSTEM, VIDEO PROCESSING APPARATUS, AND VIDEO PROCESSING METHOD

(71) Applicant: NEC Corporation, Minato-ku, Tokyo (JP)

(72) Inventors: Florian BEYE, Tokyo (JP); Takanori IWAI, Tokyo (JP); Koichi NIHEI, Tokyo (JP); Hayato ITSUMI, Tokyo (JP); Kstsuhiko TAKAHASHI, Tokyo (JP); Yasunori BABAZAKI, Tokyo (JP); Ryuhei ANDO, Tokyo (JP); Jun PIAO, Tokyo (JP)

(73) Assignee: NEC Corporation, Minato-ku, Tokyo (JP)

(21) Appl. No.: 18/861,257

(22) PCT Filed: Jul. 14, 2022
(86) PCT No.: PCT/JP2022/027706

§ 371 Date: Oct. 29, 2024

(51) Int. Cl. G06V 10/70; G06V 10/774; G06V 10/776; G06V 10/94; G06V 10/98; G06V 20/40; G06V 40/20

(52) U.S. Cl. CPC G06V 10/87; G06V 10/7747; G06V 10/776; G06V 20/41; G06V 10/95; G06V 10/993; G06V 40/23

(57) ABSTRACT

A video processing system (10) according to the present disclosure includes a recognition model (M1), a recognition model (M2), a recognition model (M3), and a recognition model (M4) that have learned video learning data corresponding to different video quality parameters, for each of the video quality parameters; and a selection unit (11) that selects a recognition model that performs recognition regarding a target included in the video input data to be input, from among the recognition model (M1), the recognition model (M2), the recognition model (M3), and the recognition model (M4), according to a video quality parameter of the video input data.

### TECHNICAL FIELD

The present disclosure relates to a video processing system, a video processing apparatus, and a video processing method.

### BACKGROUND ART

Techniques for detecting an object including a person, techniques for recognizing a behavior of an object including a person and a state of an object, and the like have been developed on the basis of a captured image and a video including an image. For example, a recognition model using machine learning is used for object detection, behavior recognition, and state recognition. The recognition model is also referred to as a learning model, an analysis model, or a recognition engine.

Patent Literature 1 is known as a related technique. Patent Literature 1 describes a technique of selecting different learning models for subject detection according to an imaging element or the like that has generated an image.

### CITATION LIST

### Patent Literature

Patent Literature 1: Japanese Unexamined Patent Application Publication No. 2019-186918

### SUMMARY OF INVENTION

### Technical Problem

As described above, in the related technique such as Patent Literature 1, a recognition model is selected according to an imaging element or the like, and an object or the like is recognized by the selected recognition model. However, in the related technique, a case where the quality of the acquired video dynamically fluctuates is not considered. For example, in a case where an object or the like is recognized on the basis of a video acquired via a network, the recognition accuracy may be decreased in the related technique. For example, this is because, in a case where a video is acquired via a network, the quality of the video captured by an imaging device may be changed by compression or the like and transmitted, and erroneous recognition due to image quality fluctuation occurs.

In view of such a problem, an object of the present disclosure is to provide a video processing system, a video processing apparatus, and a video processing method capable of improving recognition accuracy.

### Solution to Problem

A video processing system according to the present disclosure includes a plurality of recognition models that has learned video learning data corresponding to different video quality parameters, for each of the video quality parameters; and selection means for selecting a recognition model that performs recognition regarding a target included in video input data to be input, according to a video quality parameter of the video input data.

A video processing apparatus according to the present disclosure includes a plurality of recognition models that has learned video learning data corresponding to different video quality parameters, for each of the video quality parameters; and selection means for selecting a recognition model that performs recognition regarding a target included in video input data to be input, according to a video quality parameter of the video input data.

A video processing method according to the present disclosure includes acquiring video input data; and selecting a recognition model that performs recognition regarding a target included in the video input data, according to a video quality parameter of the video input data, from a plurality of recognition models that has learned video learning data corresponding to different video quality parameters, for each of the video quality parameters.

### Advantageous Effects of Invention

According to the present disclosure, it is possible to provide a video processing system, a video processing apparatus, and a video processing method capable of improving the recognition accuracy.

### BRIEF DESCRIPTION OF DRAWINGS

FIG. 1 is a configuration diagram illustrating an outline of a video processing system according to an example embodiment.

FIG. 2 is a configuration diagram illustrating an outline of a video processing apparatus according to an example embodiment.

FIG. 3 is a configuration diagram illustrating an outline of a video processing apparatus according to an example embodiment.

FIG. 4 is a flowchart illustrating an outline of a video processing method according to an example embodiment.

FIG. 5 is a diagram for describing a video processing method according to an example embodiment.

FIG. 6 is a configuration diagram illustrating a basic configuration of a remote monitoring system according to an example embodiment.

FIG. 7 is a configuration diagram illustrating a configuration example of a learning apparatus according to a first example embodiment.

FIG. 8 is a diagram illustrating a specific example of a correspondence table according to the first example embodiment.

FIG. 9 is a configuration diagram illustrating a configuration example of a terminal according to the first example embodiment.

FIG. 10 is a configuration diagram illustrating a configuration example of a center server according to the first example embodiment.

FIG. 11 is a flowchart illustrating an operation example of the learning apparatus according to the first example embodiment.

FIG. 12 is a flowchart illustrating an operation example of the terminal according to the first example embodiment.

FIG. 13 is a flowchart illustrating an operation example of the center server according to the first example embodiment.

FIG. 14 is a diagram for describing an operation example of the center server according to the first example embodiment.

FIG. 15 is a configuration diagram illustrating another configuration example of the center server according to the first example embodiment.

FIG. 16 is a configuration diagram illustrating a configuration example of a learning apparatus according to a second example embodiment.

FIG. 17 is a diagram illustrating a specific example of a correspondence table according to the second example embodiment.

FIG. 18 is a configuration diagram illustrating a configuration example of a terminal according to the second example embodiment.

FIG. 19 is a configuration diagram illustrating a configuration example of a center server according to the second example embodiment.

FIG. 20 is a flowchart illustrating an operation example of the learning apparatus according to the second example embodiment.

FIG. 21 is a flowchart illustrating an operation example of the terminal according to the second example embodiment.

FIG. 22 is a flowchart illustrating an operation example of the center server according to the second example embodiment.

FIG. 23 is a flowchart illustrating an operation example of a center server according to a third example embodiment.

FIG. 24 is a diagram illustrating a specific example of a correspondence table according to the third example embodiment.

FIG. 25 is a diagram for describing an operation example of the center server according to the third example embodiment.

FIG. 26 is a configuration diagram illustrating a configuration example of a remote monitoring system according to a fourth example embodiment.

FIG. 27 is a configuration diagram illustrating an outline of hardware of a computer according to an example embodiment.

### EXAMPLE EMBODIMENT

Hereinafter, example embodiments will be described with reference to the drawings. In the drawings, the same elements are denoted by the same reference signs, and redundant description will be omitted as necessary.

### Outline of Example Embodiment

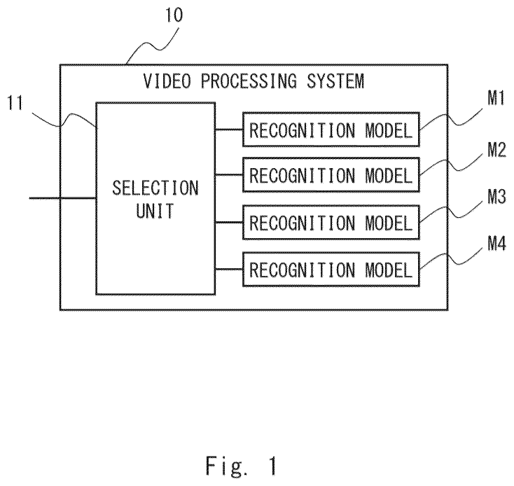

First, an outline of an example embodiment will be described. FIG. 1 illustrates a schematic configuration of a video processing system 10 according to the example embodiment. For example, the video processing system 10 is applicable to a remote monitoring system that collects videos via a network and recognizes the videos.

As illustrated in FIG. 1, the video processing system 10 includes recognition models M1 to M4 and a selection unit 11. The recognition models M1 to M4 are recognition models in which video learning data corresponding to different video quality parameters is learned for each video quality parameter. The video learning data is learning data including a video for learning an operation to be recognized by the recognition model. At the time of learning, the recognition model learns an operation, a state, a feature, and the like of a target to be recognized by the input video learning data. For example, the recognition model can recognize the type of the object in the video by learning a relationship between the video learning data including the object and the type of the object. For example, the recognition model M1 learns video learning data corresponding to a first video quality parameter, the recognition model M2 learns video learning data corresponding to a second video quality parameter, the recognition model M3 learns video learning data corresponding to a third video quality parameter, and the recognition model M4 learns video learning data corresponding to a fourth video quality parameter. For example, in a case where a video corresponding to the first video quality parameter is analyzed, recognition accuracy of the recognition model M1 is the highest, in a case where a video corresponding to the second video quality parameter is analyzed, recognition accuracy of the recognition model M2 is the highest, in a case where a video corresponding to the third video quality parameter is analyzed, recognition accuracy of the recognition model M3 is the highest, and in a case where a video corresponding to the fourth video quality parameter is analyzed, recognition accuracy of the recognition model M4 is the highest. The recognition models M1 to M4 recognize, for example, a face of a person, a vehicle, an instrument, and the like according to the input video. In addition, for example, the recognition models M1 to M4 may recognize a behavior of a person, a traveling situation of a vehicle, a state of an object, and the like. Note that a recognition target to be recognized by the recognition models M1 to M4 is not limited to these examples. The number of recognition models is not limited to four, and any number of recognition models may be included. Note that, in the video processing system 10, a recognition model that has learned the video learning data may be generated, or a trained recognition model may be acquired. In the case of acquiring the trained recognition model, videos having different video quality parameters may be input to the acquired recognition model, and the recognition accuracy may be measured to determine the most accurate recognition model for each video quality parameter.

The video quality parameter is a parameter or an index indicating the quality of the video. For example, the video quality parameter is a video parameter such as a bit rate or a frame rate which is a compression degree of a video. In addition, the video quality parameter may be an index indicating image quality such as resolution of an image included in the video. The image quality index indicating the image quality may be Multi-Scale Structural Similarity (MS-SSIM), Peak Signal to Noise Ratio (PSNR), or the like. The image quality index is an index for evaluating the image quality after conversion, and indicates a deterioration degree of the quality of the image after conversion with respect to the image before conversion. For example, the first to fourth video quality parameters have different bit rates, and the first to fourth recognition models are recognition models that respectively learn videos having different bit rates.

The selection unit 11 selects a recognition model for performing recognition regarding a target included in video input data to be input, according to the video quality parameter of the video input. The video input data is video data input to the video processing system 10 at the time of recognition. Note that the recognition regarding the target included in the video is recognition of an object included in the video, recognition of a state related to the object, or the like, and includes, for example, recognition of an object including a person, recognition of a behavior of the person, recognition of a state of the object, or the like. The recognition regarding the target included in the video is also referred to as video recognition. For example, the selection unit 11 selects the recognition model M1 in a case where the video quality parameter of the video input data is the first video quality parameter, selects the recognition model M2 in a case where the video quality parameter of the video input data is the second video quality parameter, selects the recognition model M3 in a case where the video quality parameter of the video input data is the third video quality parameter, and selects the recognition model M4 in a case where the video quality parameter of the video input data is the fourth video quality parameter. The video input data is video data on which at least one of the recognition models M1 to M4 performs the video recognition processing, and includes recognition targets such as a face of a person, a vehicle, and an instrument. In a case where the video input data is input to a plurality of recognition models among the recognition models M1 to M4, the plurality of recognition models may perform the video recognition processing. The selection unit 11 selects a recognition model from the recognition models M1 to M4, and inputs the video input data to the selected recognition model.

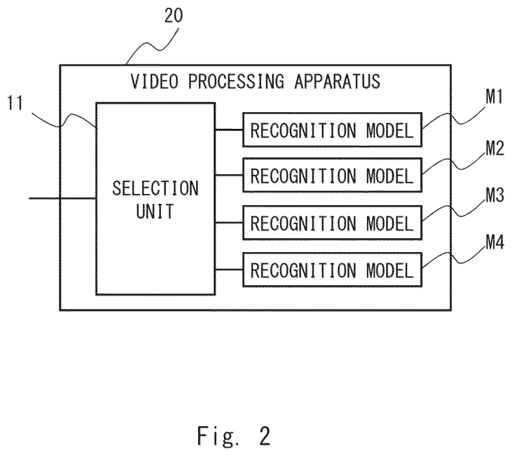

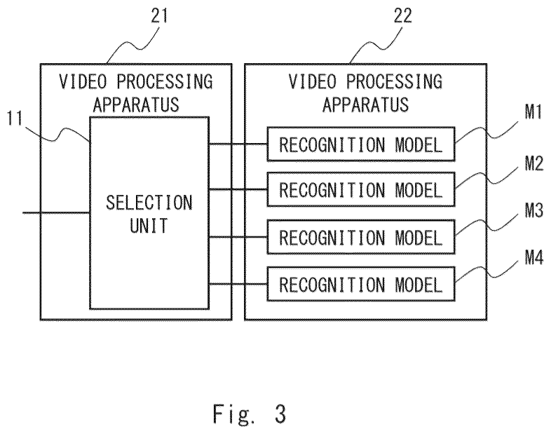

Note that the video processing system 10 may be configured by one apparatus or a plurality of apparatuses. FIG. 2 illustrates a configuration of a video processing apparatus 20 according to the example embodiment. As illustrated in FIG. 2, the video processing apparatus 20 may include the recognition models M1 to M4 and the selection unit 11 illustrated in FIG. 1. In addition, a part or all of the video processing system 10 may be arranged on an edge or a cloud. For example, the recognition models M1 to M4 and the selection unit 11 may be arranged in a server of a cloud. Furthermore, each function may be distributed in the cloud. FIG. 3 illustrates a configuration in which functions of the video processing system 10 are arranged in a plurality of video processing apparatuses. In the example of FIG. 3, a video processing apparatus 21 includes the selection unit 11, and a video processing apparatus 22 includes the recognition models M1 to M4. Note that the configuration of FIG. 3 is an example, and the present invention is not limited to this configuration.

In addition, the recognition models M1 to M4 may be arranged at the same point or may be arranged at different points. For example, any recognition model among the recognition models M1 to M4 may be arranged on one of the edge and the cloud, and the other recognition models may be arranged on the other of the edge and the cloud.

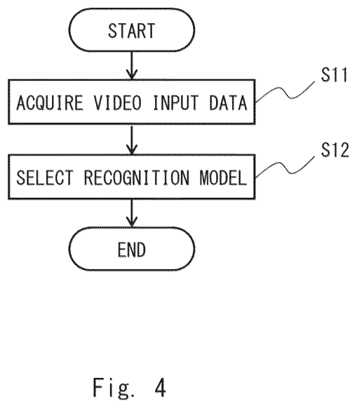

FIG. 4 illustrates a video processing method according to the example embodiment. For example, the video processing method according to the example embodiment is executed by the video processing system 10 or the video processing apparatuses 20 to 22 of FIGS. 1 to 3. As illustrated in FIG. 4, video input data is acquired (S11), and a recognition model for performing recognition regarding the target included in the video input data is selected from the recognition models M1 to M4 which has learned the video learning data corresponding to different video quality parameters for each video quality parameter, according to the video quality parameter of the video input data (S12).

Here, an example will be considered in which a video is transmitted from a terminal to a server via a network and the server recognizes the video using a recognition model. In a system in which a camera video is network-transmitted from a terminal and processed by a recognition model on a server side, in order to reduce a network load, there is a case where the video quality of the video data to be transferred is lowered by compressing the video, for example. In such a case, there is a possibility that the recognition accuracy of the recognition model is decreased due to the fluctuation in the video quality. Therefore, in the example embodiment, in a case where the video quality fluctuates, the optimum recognition model is selected from among the plurality of recognition models, and the recognition accuracy can be improved.

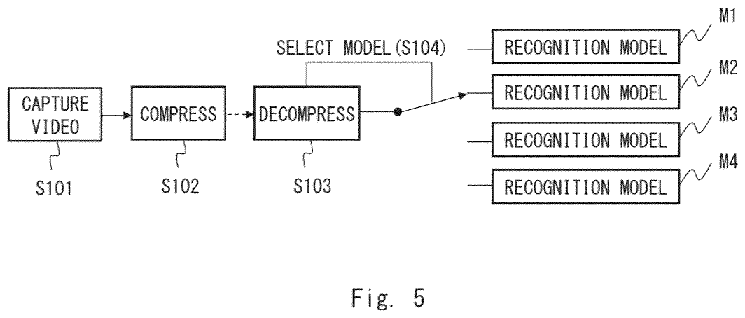

FIG. 5 illustrates an operation example in a case where any one of the recognition models M1 to M4 in FIG. 1 is selected in the video processing method according to the example embodiment. For example, the recognition models M1 to M4 are recognition models that have learn the videos with different bit rates. Note that, here, as an example, the compressed and decompressed video is input to the recognition model, but the present invention is not limited to this configuration as long as the video that can be recognized can be input to each recognition model. For example, the video processing system that executes the video processing method of FIG. 5 may further include an imaging unit that captures a video, a compression unit that compresses the video, and a decompression unit that decompresses, that is, expands the compressed video, in addition to the configuration of FIG. 1. Note that since the example of FIG. 5 is an example of operating according to the bit rate of the video after decompression, the example embodiment is not limited to the example of FIG. 5, and for example, the video processing system that executes the video processing method of FIG. 5 may not include the compression unit and the decompression unit.

As illustrated in FIG. 5, in the video processing method according to the example embodiment, the imaging unit captures a video (S101), and the compression unit compresses the captured video (S102). Next, the compressed video is transmitted from the compression unit to the decompression unit, and the decompression unit decompresses the received compressed video (S103). Next, the selection unit selects a recognition model according to the bit rate of the video (S104), and inputs the video to the selected recognition model. The selected recognition model performs the video recognition using the input video.

Usually, the recognition model is trained and constructed using the video data in which the video quality such as a bit rate and a frame rate of the input video is set to be constant, and the recognition accuracy tends to be decreased for a video with a video quality that the recognition model has not learned. That is, the recognition accuracy is high in a case where the video quality is close between the time of learning and the time of recognition, the recognition accuracy is decreased in a case where the video quality is different. Therefore, in the example embodiment, a plurality of recognition models that has learned the video for each video quality parameter are prepared, and the recognition model is selected according to the video quality parameter of the input video, so that the optimum recognition model can be selected to improve the recognition accuracy.

### (Basic Configuration of Remote Monitoring System)

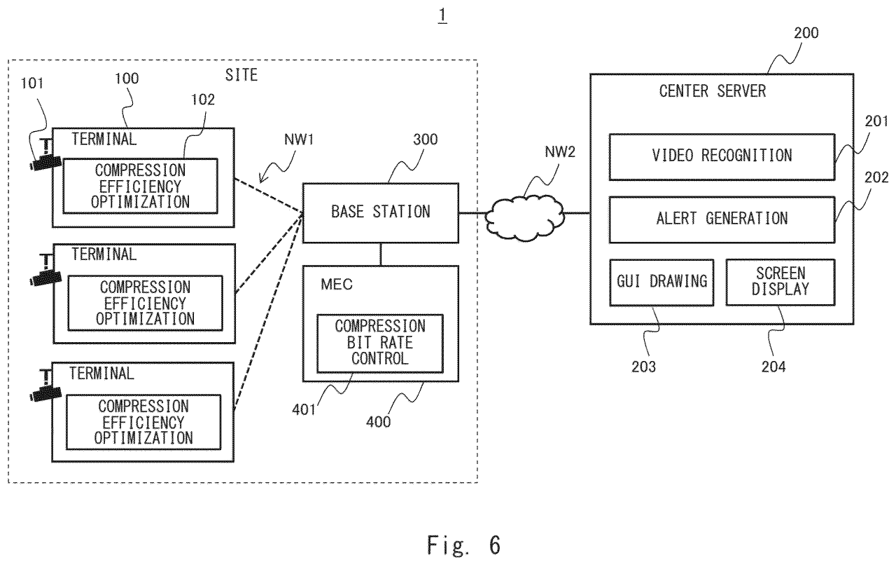

Next, a remote monitoring system which is an example of a system to which the example embodiment is applied will be described. FIG. 6 illustrates a basic configuration of a remote monitoring system 1. The remote monitoring system 1 is a system that monitors a captured area using a video captured by a camera. Hereinafter, the present example embodiment will be described as a system that remotely monitors work of a worker at a site. For example, the site may be an area where people and machines operate, such as a work site such as a construction site, a square where people gather, or a school. In the present example embodiment, hereinafter, the work will be described as construction work, civil engineering work, or the like, but the work is not limited thereto. Note that, since the video includes a plurality of time-series images, that is, frames), the video and the image can be paraphrased with each other. That is, the remote monitoring system can be said to be a video processing system that processes a video and an image processing system that processes an image.

As illustrated in FIG. 6, the remote monitoring system 1 includes a plurality of terminals 100, a center server 200, a base station 300, and MEC 400. The terminal 100, the base station 300, and the MEC 400 are disposed on the site side, and the center server 200 is disposed on the center side. For example, the center server 200 is disposed in a data center or the like disposed at a position away from the site. The site side is also referred to as an edge side of the system, and the center side is also referred to as a cloud side.

The terminal 100 and the base station 300 are communicably connected by a network NW1. The network NW1 is, for example, a wireless network such as 4G, local 5G/5G, long term evolution (LTE), or wireless LAN. Note that the network NW1 is not limited to a wireless network, and may be a wired network. The base station 300 and the center server 200 are communicably connected by a network NW2. The network NW2 includes, for example, a core network such as a 5th Generation Core network (5GC) or an Evolved Packet Core (EPC), the Internet, and the like. Note that the network NW2 is not limited to a wired network, and may be a wireless network. It can also be said that the terminal 100 and the center server 200 are communicably connected via the base station 300. The base station 300 and the MEC 400 are communicably connected by an arbitrary communication method, but the base station 300 and the MEC 400 may be one apparatus.

The terminal 100 is a terminal apparatus connected to the network NW1, and is also a video distribution apparatus that distributes a video of the site. The terminal 100 acquires a video captured by a camera 101 installed at the site, and transmits the acquired video to the center server 200 via the base station 300. Note that the camera 101 may be disposed outside the terminal 100 or inside the terminal 100.

The terminal 100 compresses the video of the camera 101 to a predetermined bit rate, and transmits the compressed video. The terminal 100 has a compression efficiency optimization function 102 that optimizes compression efficiency. The compression efficiency optimization function 102 includes a region of interest (ROI) control to control image quality in the ROI in the video. The ROI is a predetermined region in the video. The ROI may be a region including a recognition target of the recognition model of the center server 200, or may be a region to be gazed by the user. The compression efficiency optimization function 102 reduces the bit rate by reducing the image quality of the region around the ROI including the person or the object while maintaining the image quality of the ROI.

The base station 300 is a base station apparatus of the network NW1, and is also a relay apparatus that relays communication between the terminal 100 and the center server 200. For example, the base station 300 is a local 5G base station, a 5G next generation node B (gNB), an LTE evolved node B (eNB), an access point of a wireless LAN, or the like, but may be another relay apparatus.

The multi-access edge computing (MEC) 400 is an edge processing apparatus disposed on the edge side of the system. The MEC 400 is an edge server that controls the terminal 100, and has a compression bit rate control function 401 that controls a bit rate of the terminal. The compression bit rate control function 401 controls a bit rate of the terminal 100 by adaptive video distribution control or quality of experience (QoE) control. The adaptive video distribution control controls a bit rate or the like of a video to be distributed according to a situation of a network. For example, the compression bit rate control function 401 predicts the recognition accuracy obtained when the video is input to the recognition model by suppressing the bit rate of the distributed video, according to a communication environment of the networks NW1 and NW2, and allocates the bit rate to the video distributed by the camera 101 of each terminal 100 so as to improve the recognition accuracy. Note that the control is not limited to the control of the bit rate, and the frame rate of the video to be distributed may be controlled according to the situation of the network.

The center server 200 is a server installed on the center side of the system. The center server 200 may be one or a plurality of physical servers, a cloud server built on a cloud, or other virtualization servers. The center server 200 is a monitoring apparatus that monitors work at a site by analyzing and recognizing a camera video of the site. The center server 200 is also a video reception apparatus that receives a video transmitted from the terminal 100.

The center server 200 has a video recognition function 201, an alert generation function 202, a GUI drawing function 203, and a screen display function 204. The video recognition function 201 inputs the video transmitted from the terminal 100 to a video recognition artificial intelligence (AI) engine, thereby recognizing the work performed by the worker, that is, the type of behavior of the person. The video recognition function 201 may include a plurality of recognition models that analyzes videos corresponding to different video quality parameters. Furthermore, the center server 200 may include a selection unit that selects the recognition models according to the video quality parameter.

The alert generation function 202 generates an alert according to the recognized work. The GUI drawing function 203 displays a graphical user interface (GUI) on a screen of the display device. The screen display function 204 displays a video, a recognition result, an alert, and the like of the terminal 100 on the GUI. Note that any of the functions may be omitted or any of the functions may be included as necessary. For example, the center server 200 may not include the alert generation function 202, the GUI drawing function 203, and the screen display function 204.

### First Example Embodiment

Next, a first example embodiment will be described. In the present example embodiment, an example will be described in which a recognition model is generated and selected on the basis of a bit rate that is a compression degree of a video. Note that not only the bit rate but also another index indicating a compression degree may be used. Hereinafter, configurations and operations at the time of learning and recognition of the recognition model will be described in detail.

### <Configuration at Time of Learning>

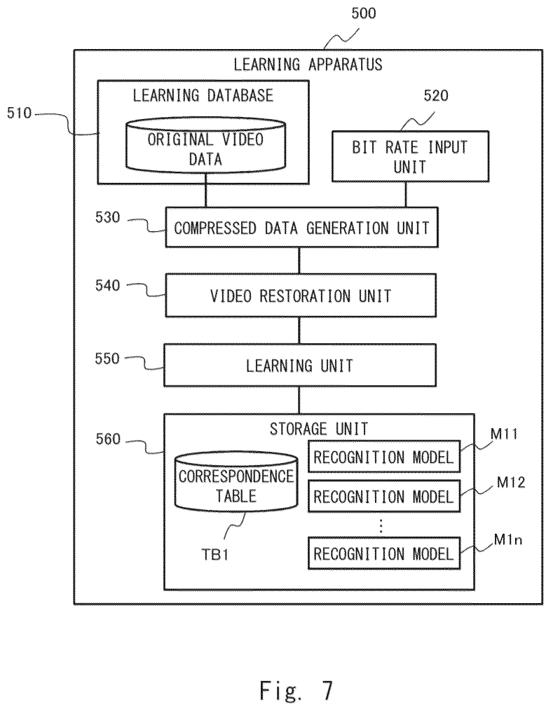

First, as a configuration example at the time of learning according to the present example embodiment, a configuration of a learning apparatus that generates a recognition model will be described. Note that, here, an example in which the learning apparatus learns a video to generate a recognition model will be described, but the present invention is not limited thereto, and a trained model may be acquired from the outside. FIG. 7 illustrates a configuration example of the learning apparatus according to the present example embodiment.

As illustrated in FIG. 7, a learning apparatus 500 according to the present example embodiment includes a learning database 510, a bit rate input unit 520, a compressed data generation unit 530, a video restoration unit 540, a learning unit 550, and a storage unit 560. Note that the configuration is an example, and another configuration may be used as long as the operation according to the present example embodiment described below can be performed. For example, the learning database 510 and the storage unit 560 may be external storage devices.

The learning database 510 stores original video data used for learning. The original video data is video data before compression, and is learning data for causing the recognition model to learn. For example, in a case where a recognition model for behavior recognition is generated, a video obtained by imaging a behavior of a person is used as the learning data. The learning database 510 may store compressed video data and other data necessary for learning.

The bit rate input unit 520 inputs a bit rate that is a compression degree of a video to be learned by the recognition model. The bit rate to be input is a bit rate used in augmentation for generating the learning data. In order to generate a recognition model trained for each bit rate, a plurality of bit rates is input. Not only the bit rate but also a bit rate range may be input. The bit rate range indicates a width of the bit rate, such as a first bit rate to a second bit rate. For example, the bit rate range may be 11 bps to 20 bps or may be 21 bps to 30 bps. For example, the bit rate input unit 520 may acquire a bit rate input by the user, or may acquire a bit rate set in advance in the storage unit 560 or the like.

The compressed data generation unit 530 generates compressed data obtained by compressing the original video data stored in the learning database 510 at the input bit rate. In a case where the bit rate range is input, the compressed data generation unit 530 generates compressed data within the bit rate range. Note that compressed data compressed at each bit rate in advance may be acquired from the learning database 510. The compressed data generation unit 530 is also a learning data generation unit that generates a data set of learning data. The compressed data generation unit 530 performs augmentation for each bit rate, and generates compressed data of an augmentation pattern necessary for learning for each bit rate.

The compressed data generation unit 530 compresses the original video data at a predetermined bit rate by encoding the original video data by a predetermined encoding system. That is, the compressed data generation unit 530 is an encoder that encodes the original video data at a predetermined bit rate. The compressed data generation unit 530 performs encoding by a video encoding system such as H.264 or H.265, for example.

The video restoration unit 540 generates restoration data obtained by restoring the original video data, from the generated compressed data. The video restoration unit 540 is an expansion unit that expands the generated compressed data at a compressed bit rate. The video restoration unit 540 expands and restores the compressed data by decoding the compressed data by a predetermined encoding system. That is, the video restoration unit 540 is a decoder that decodes the compressed data at a bit rate of the compressed data. The video restoration unit 540 is compatible with the encoding system of the compressed data generation unit 530, and performs decoding by a video encoding system such as H.264 or H.265.

The learning unit 550 performs machine learning using the generated restoration data. The learning unit 550 performs machine learning such as deep learning to generate a trained recognition model. The learning unit 550 performs machine learning with the restoration data compressed and restored for each input bit rate, and generates recognition models M11 to Mln (n is an arbitrary natural number of 2 or more) that have learned the video for each bit rate. In a case where a bit rate range is input, a recognition model is generated by learning the video for each bit rate range. For example, by performing machine learning of the feature of the video of the person performing work and behavior labels, a recognition model that recognizes the behavior of the person in the video may be generated. The recognition model is a learning model that can learn and predict on the basis of time-series video data, and may be convolutional neural networks (CNNs), recurrent neural networks (RNNs), or other neural networks, for example.

The storage unit 560 stores the recognition models M11 to Mln that have learned the videos for each generated bit rate. In addition, the storage unit 560 stores a correspondence table TB1 in which the bit rate of the learned video is associated with the recognition model. Note that the correspondence between the bit rate and the recognition model may be performed by the learning unit 550 or may be performed by the storage unit 560.

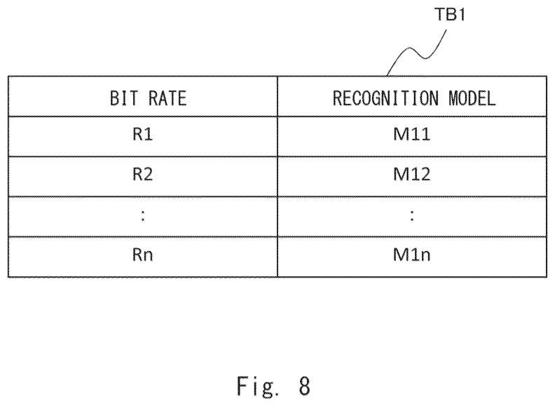

FIG. 8 illustrates a specific example of the correspondence table TB1. With the correspondence table TB1 in which the bit rate and the recognition model are associated, it is possible to select a recognition model for recognizing a video according to a bit rate of the video. In this example, a bit rate R1 and the recognition model M11 are associated, a bit rate R2 and the recognition model M12 are associated, . . . , and a bit rate Rn and the recognition model Mln are associated. That is, the recognition model M11 learns the video at the bit rate R1, the recognition model M12 learns the video at the bit rate R2, . . . , and the recognition model Mln learns the video at the bit rate Rn. The bit rates R1 to Rn are different bit rates, and have, for example, a relationship of R1>R2> . . . >Rn, but are not limited thereto. The intervals of the respective bit rates may be equal intervals or different intervals. For example, in a case where the influence of the fluctuation in the bit rate on the recognition accuracy is greater at the low bit rate, the interval of the low bit rates may be narrower that of the high bit rates.

In addition, the bit rates R1 to Rn may be bit rate ranges each having a width. For example, the bit rate R1 may be 11 bps to 20 bps, and the bit rate R2 may be 21 bps to 30 bps. In addition, each bit rate range may overlap between adjacent ranges. As in the case of the above bit rates, the widths of the bit rate ranges may be equal to each other or different from each other.

### <Configuration at Time of Recognition>

Next, as a configuration example at the time of recognition according to the present example embodiment, a configuration of a remote monitoring system that remotely performs video recognition will be described. A basic configuration of the remote monitoring system 1 according to the present example embodiment is as illustrated in FIG. 6. Here, configurations of the terminal and the center server will be described.

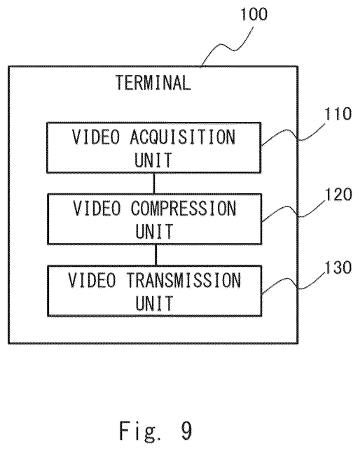

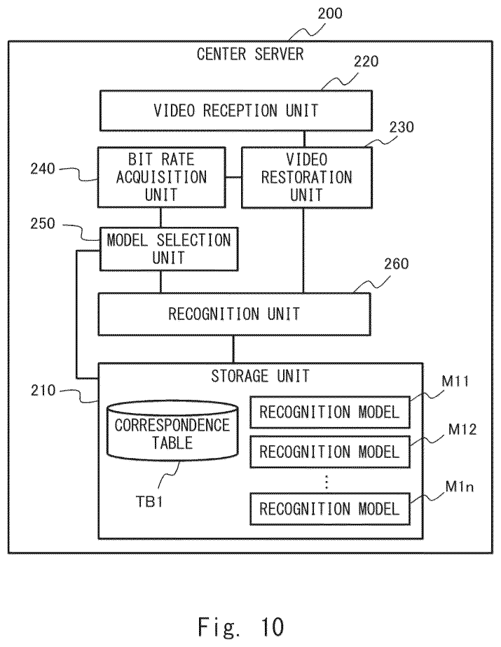

FIG. 9 illustrates a configuration example of the terminal 100 according to the present example embodiment, and FIG. 10 illustrates a configuration example of the center server 200 according to the present example embodiment. Note that the configuration of each apparatus is an example, and another configuration may be used as long as the operation according to the present example embodiment described below can be performed. For example, some functions of the terminal 100 may be disposed in the center server 200 or another apparatus, or some functions of the center server 200 may be disposed in the terminal 100 or another apparatus. In addition, the functions of the MEC 400 including the compression bit rate control function may be disposed in the center server 200 or the like. As illustrated in FIG. 9, the terminal 100 according to the present example embodiment includes a video acquisition unit 110, a video compression unit 120, and a video transmission unit 130.

The video acquisition unit 110 acquires a video captured by the camera 101. The video captured by the camera is hereinafter also referred to as an input video. For example, the input video includes a person who is a worker who performs work at a site. The video acquisition unit 110 is also an image acquisition unit that acquires a plurality of time-series images, that is, frames.

The video compression unit 120 generates a compressed video obtained by compressing the acquired input video at a predetermined bit rate. The video compression unit 120 compresses the input video at a predetermined bit rate by encoding the input video by a predetermined encoding system. That is, the video compression unit 120 is an encoder that encodes the input video at a predetermined bit rate. Similarly to the learning apparatus 500, the video compression unit 120 performs encoding by a video encoding system such as H.264 or H.265, for example.

The video compression unit 120 may encode the input video at a bit rate allocated from the compression bit rate control function 401 of the MEC 400. In addition, the video compression unit 120 may determine the bit rate on the basis of the communication quality between the terminal 100 and the center server 200. The communication quality is, for example, a communication speed, but may be another index such as a transmission delay or an error rate. The terminal 100 may include a communication quality measurement unit that measures communication quality. For example, the communication quality measurement unit determines the bit rate of the video to be transmitted from the terminal 100 to the center server 200 according to the communication speed. The communication speed may be measured on the basis of the data amount received by the base station 300 or the center server 200, and the communication quality measurement unit may acquire the measured communication speed from the base station 300 or the center server 200. In addition, the communication quality measurement unit may estimate the communication speed on the basis of the data amount per unit time transmitted from the video transmission unit 130.

The video compression unit 120 may detect an ROI including a person and encode the input video such that the detected ROI has higher image quality than other regions. An ROI specifying unit may be provided between the video acquisition unit 110 and the video compression unit 120. The ROI specifying unit detects an object in the acquired video, and specifies a region such as the ROI. The video compression unit 120 may encode the input video such that the ROI specified by the ROI specifying unit has higher image quality than other regions. In addition, the input image may be encoded such that the image quality of the region designated by the ROI specifying unit is lower than that of other regions. In a case of detecting or specifying the ROI, the ROI specifying unit or the video compression unit 120 may hold information in which an object that may appear in a video is associated with its priority, and specify a region such as the ROI according to the correspondence information of the priority.

The video transmission unit 130 transmits the compressed video generated by video compression unit 120 to the center server 200 via the base station 300. The video transmission unit 130 is a distribution unit that distributes the acquired input video via the network. The video transmission unit 130 is a communication interface capable of communicating with the base station 300, and is, for example, a wireless interface such as 4G, local 5G/5G, LTE, or a wireless LAN, but may be a wireless or wired interface of any other communication system.

In addition, as illustrated in FIG. 10, the center server 200 according to the present example embodiment includes a storage unit 210, a video reception unit 220, a video restoration unit 230, a bit rate acquisition unit 240, a model selection unit 250, and a recognition unit 260.

The storage unit 210 stores the recognition models M11 to M1n that have learned the video for each bit rate or bit rate range and are generated by the learning apparatus 500, and the correspondence table TB1 in which the bit rate or bit rate range is associated with the recognition model. That is, the storage unit 210 stores the same data as the storage unit 560 of the learning apparatus 500. For example, the storage unit 210 acquires the recognition models M11 to M1n and the correspondence table TB1 from the storage unit 560 of the learning apparatus 500. The information may be acquired via a network or the like, or may be acquired using a storage medium or the like. The storage unit 210 may be the same storage device as the storage unit 560 of the learning apparatus 500. The video reception unit 220 receives the compressed video transmitted from the terminal 100 via the base station 300. The video reception unit 220 receives the input video acquired and distributed by the terminal 100 via the network. The video reception unit 220 is a communication interface capable of communicating with the Internet or a core network, and is, for example, a wired interface for IP communication, but may be a wired or wireless interface of any other communication system.

The video restoration unit 230 restores the original video from the received compressed video. The restored video is hereinafter also referred to as a received video. The video restoration unit 230 is an expansion unit that expands the compressed video received from the terminal 100, at a predetermined bit rate. The video restoration unit 230 expands and restores the compressed video by decoding the compressed video by a predetermined encoding system. That is, the video restoration unit 230 is a decoder that decodes the compressed video at a bit rate of the compressed video. The video restoration unit 230 is compatible with the encoding system of the terminal 100, and performs decoding by a video encoding system such as H.264 or H.265. The video restoration unit 230 decodes the video according to the compression rate or the bit rate of each region, and generates a decoded video.

The bit rate acquisition unit 240 acquires a bit rate which is a compression degree of the restored received video. For example, the bit rate acquisition unit 240 may measure the data amount per unit time in the compressed video received by video reception unit 220, and may acquire the bit rate. In addition, the terminal 100 may transmit a packet including the compressed video and the bit rate, and the bit rate acquisition unit 240 may acquire the bit rate from the received packet.

The model selection unit 250 selects a recognition model for analyzing the received video, according to the bit rate that is a compression degree of the received video. The model selection unit 250 is a switching unit that switches a recognition model for analyzing the received video, according to the bit rate of the received video. The model selection unit 250 selects a recognition model corresponding to the bit rate of the received video from among the recognition models M11 to M1n on the basis of the correspondence table TB1 of the storage unit 210. The model selection unit 250 specifies the bit rate closest to the bit rate of the received video from the correspondence table TB1 of the storage unit 210, and selects the recognition model corresponding to the specified bit rate. In a case where the recognition model is associated with each bit rate range, the recognition model may be selected on the basis of the bit rate range corresponding to the bit rate of the received video. For example, the recognition model corresponding to the bit rate range closest to the bit rate of the received video or the bit rate range including the bit rate of the received video may be selected.

The recognition unit 260 analyzes the received video by using the selected recognition model. The recognition unit 260 performs video recognition by inputting the restored received video to the recognition model selected from among the recognition models M11 to M1n of the storage unit 210. For example, the recognition model recognizes a behavior or the like of a person from the input received video, and outputs a recognition result.

### <Operation at Time of Learning>

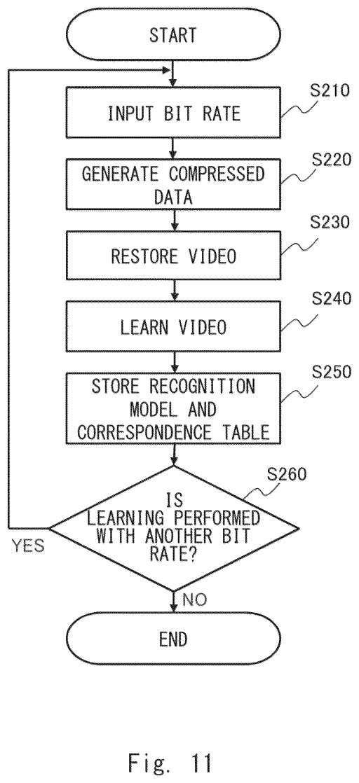

Next, as an operation example at the time of learning according to the present example embodiment, an operation in which the learning apparatus learns the compressed data will be described. FIG. 11 illustrates an operation example of the learning apparatus 500 according to the present example embodiment.

As illustrated in FIG. 11, the bit rate is input to the learning apparatus 500 (S210). For example, the user inputs a bit rate or a bit rate range of a video to be learned by the recognition model, and the bit rate input unit 520 receives the input bit rate or bit rate range. For example, the bit rate range may be a compression level such as a high level, a medium level, or a low level. A specific bit rate range of the high level, the medium level, and the low level may be set in advance.

Subsequently, the learning apparatus 500 generates compressed data obtained by compressing the original video data (S220). The compressed data generation unit 530 acquires the original video data from the learning database 510, and compresses the original video data by encoding the original video data at the input bit rate or bit rate range.

Subsequently, the learning apparatus 500 generates restoration data obtained by restoring the original video data, from the generated compressed data (S230). The video restoration unit 540 expands and restores the compressed data by decoding the compressed data at the compressed bit rate or bit rate range.

Subsequently, the learning apparatus 500 learns the generated restoration data (S240). The learning unit 550 performs machine learning using the generated restoration data, and generates a trained recognition model that has learned the video of the input bit rate or bit rate range. The recognition model can recognize the recognition target from the compressed video by learning the recognition target appearing in the video based on the compressed video.

Subsequently, the learning apparatus 500 stores the generated recognition model and correspondence table (S250). The storage unit 560 stores the generated recognition model, and stores the correspondence table TB1 in which the bit rate or the bit rate range of the learned video is associated with the recognition model. Note that, in the correspondence table TB1, information of the learned image or video, the type or name of the recognition target, and the like may be stored in association with each other.

Subsequently, the learning apparatus 500 determines whether or not to perform learning with another bit rate (S260). In a case of performing learning with another bit rate, learning is performed by repeating S210 and subsequent steps, and in a case of not performing learning with another bit rate, the processing is ended. For example, the learning apparatus 500 performs learning using the same original video data at each compression level of the high level, the medium level, and the low level. Note that, after all the learning is completed, the recognition model and the correspondence table of the storage unit 560 are stored in the storage unit 210 of the center server 200.

### <Operation at Time of Recognition>

Next, as an operation example at the time of recognition according to the present example embodiment, an operation in which the remote monitoring system remotely recognizes a video will be described.

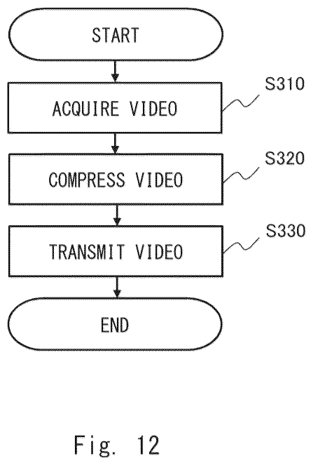

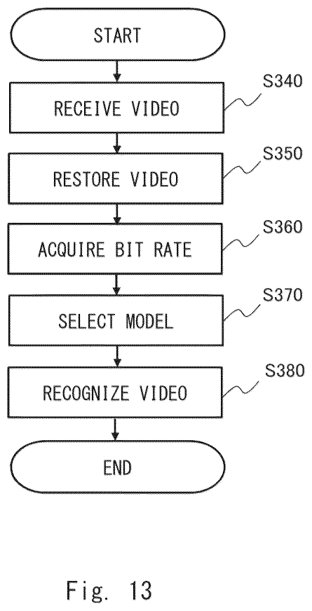

FIG. 12 illustrates an operation example of the terminal 100 according to the present example embodiment, and FIG. 13 illustrates an operation example of the center server 200 according to the present example embodiment. Note that, it is described that the terminal 100 executes S310 to S330 of FIG. 12 and the center server 200 executes S340 to S380 of FIG. 13, but the present invention is not limited thereto, and any apparatus may execute each processing.

Some functions of the center server 200 may be arranged in another apparatus, and the other apparatus may execute the functions. For example, the terminal 100 or the MEC 400 may include the bit rate acquisition unit 240 and the model selection unit 250, and store the correspondence table TB1. The terminal 100 or the MEC 400 may select a recognition model on the basis of the acquired bit rate at which the video is compressed, and notify the center server 200 of an instruction of the selected recognition model. Note that the present invention is not limited to the present example embodiment, and the same applies to other example embodiments.

As illustrated in FIG. 12, first, the terminal 100 acquires a video from the camera 101 (S310). The camera 101 generates a video obtained by imaging the site, and the video acquisition unit 110 acquires a video, that is, input video output from the camera 101. For example, the image of the input video includes a person who performs work at a site, an object used for work, and the like.

Subsequently, the terminal 100 generates a compressed video obtained by compressing the acquired input video (S320). The video compression unit 120 compresses the input video by encoding the input video at a predetermined bit rate. For example, the video compression unit 120 may encode the input video at a bit rate allocated from the compression bit rate control function 401 of the MEC 400, or may encode the input video at a bit rate according to the communication quality between the terminal 100 and the center server 200.

Subsequently, the terminal 100 transmits the generated compressed video to the center server 200 (S330). The video transmission unit 130 transmits the compressed video obtained by compressing the input video to the base station 300, and the base station 300 transfers the received compressed video to the center server 200 via the core network or the Internet.

Subsequently, as illustrated in FIG. 13, the center server 200 receives the compressed video from the terminal 100 (S340). The video reception unit 220 receives the compressed video transmitted from the terminal 100 via the base station 300.

Subsequently, the center server 200 generates the received video obtained by restoring the original video from the compressed video (S350). The video restoration unit 230 expands and restores the compressed video by decoding the received compressed video. The video restoration unit 230 decodes the compressed video according to the compression rate or the bit rate of each region, and generates a decoded video.

Subsequently, the center server 200 acquires a bit rate which is a compression degree of the received video (S360). For example, the bit rate acquisition unit 240 measures the data amount per unit time in the compressed video received by video reception unit 220, and acquires the bit rate. The bit rate acquisition unit 240 may determine whether the compression level is the high level, the medium level, or the low level on the basis of the bit rate of the received video.

Subsequently, the center server 200 selects a recognition model for analyzing the received video (S370). The model selection unit 250 selects a recognition model for analyzing the received video, according to the bit rate of the received video. For example, in a case where the compression level of the received video is the low level, a recognition model that has learned a video in the low level is selected. The model selection unit 250 determines a recognition model corresponding to the bit rate of the received video by referring to the correspondence table TB1 of the storage unit 210. In the example of the correspondence table TB1 of FIG. 8, in a case where the bit rate of the received video is the bit rate R1, the recognition model M11 is selected as the recognition model for analyzing the received video.

In a case where the bit rates R1 to Rn are the bit rate ranges, for example, the bit rate of the received video is compared with the center of each bit rate range of the correspondence table TB1, and the recognition model corresponding to the bit rate range closest to the bit rate of the received video is selected. Without being limited to the center, any value in the bit rate range may be compared with the bit rate of the received video. For example, in a case where the bit rate of the received video is in the middle of two bit rate ranges, that is, in a case where the difference between the received video and the two bit rate ranges is the same, a recognition model corresponding to one of the bit rate ranges may be used, or a recognition model corresponding to the two bit rate ranges may be selected.

Subsequently, the center server 200 performs video recognition on the received video by the selected recognition model (S380). The recognition unit 260 inputs the received video to the selected recognition model, and performs the video recognition on the received video. The recognition unit 260 outputs a recognition result obtained by the recognition model to which the received video is input. In a case where two recognition models are selected, the received video may be input to the two recognition models, and the recognition results of the two recognition models may be output, or the recognition result of any one of the recognition models may be output. For example, the recognition result of the recognition model having the higher score of the recognition result may be output. The score of the recognition result is a certainty factor indicating the probability that the recognition result is correct.

Note that, in a case where there are regions of different bit rates in the frame, the videos of the respective regions may be analyzed by different recognition models. The bit rate acquisition unit 240 may acquire the bit rate of each region, and the model selection unit 250 may select a recognition model according to the bit rate for each region. The recognition unit 260 may collectively output the recognition results of the plurality of recognition models.

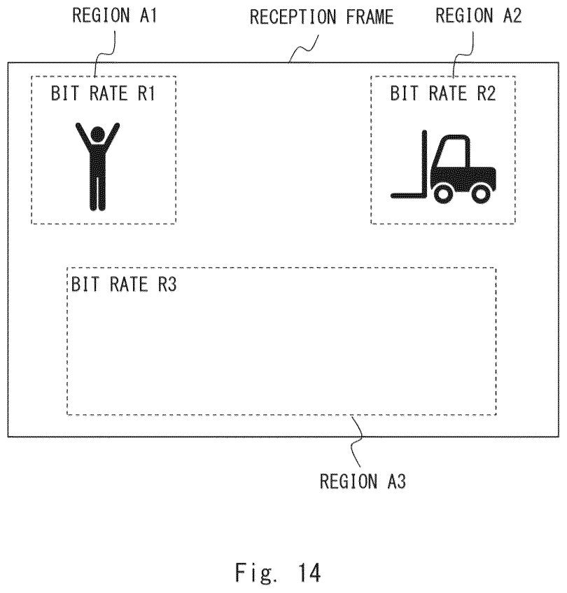

For example, as illustrated in FIG. 14, in a case where regions A1 to A3 are included in the frame, the bit rate of the region A1 is R1, the bit rate of the region A2 is R2, and the bit rate of the region A3 is R3, the model selection unit 250 selects the recognition model M11 corresponding to the bit rate R1 in the region A1, selects the recognition model M12 corresponding to the bit rate R2 in the region A2, and selects the recognition model M13 corresponding to the bit rate R3 in the region A3. The recognition models M11 to M13 analyze videos of the input regions A1 to A3, respectively, and output recognition results.

For example, the model selection unit 250 may crop an image for each region, and input the cropped image for each region to each recognition model. The entire frame may be input to each recognition model without cropping an image. For example, each region in the frame is an object region including an object, and may be a rectangular region extracted by object detection. The object region is not limited to a rectangle, and may be a region such as a circle or an amorphous silhouette. The object detection may be performed by the recognition model of the recognition unit 260, or may be performed by another object detection model.

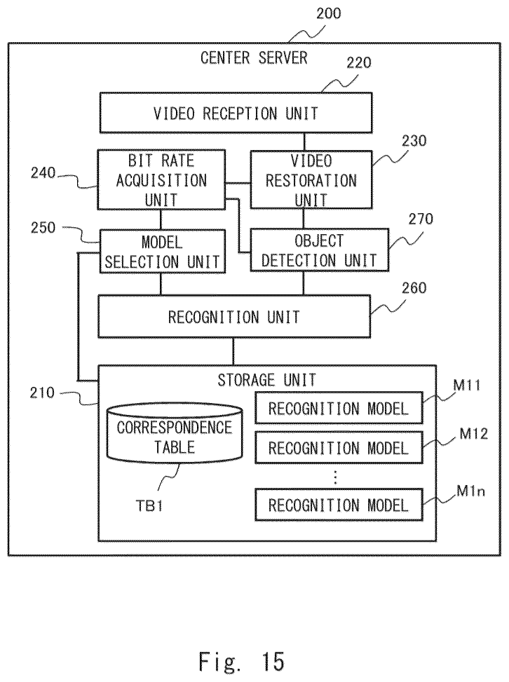

The center server 200 may perform recognition processing in multiple stages such as object detection, skeleton detection, and behavior recognition as the video recognition. For example, as illustrated in FIG. 15, the center server 200 may include an object detection unit 270 that detects an object from the received video. The object detection unit 270 detects an object from the received video and extracts an object region. The bit rate acquisition unit 240 acquires the bit rate of the extracted object region, and the model selection unit 250 selects the recognition model for analyzing the video of the object region according to the bit rate of the object region. The selected recognition model recognizes the skeleton and behavior of the person in the video of the object region, and outputs the recognition result.

Note that the processing flow illustrated in FIGS. 12 and 13 is an example, and the order of each processing is not limited thereto. The order of part of the processing may be changed and executed, or part of the processing may be executed in parallel. For example, in a case where the terminal 100 or the MEC 400 includes the bit rate acquisition unit 240 and the model selection unit 250 and stores the correspondence table TB1, S360 and S370 may be executed between S310 and S320. In addition, S360 and S370 may be executed in parallel with S310 to S350 as long as the processing is executed before the model selection.

As described above, in the present example embodiment, a plurality of recognition models is trained by changing bit rates that are compression degrees used in the augmentation at the time of learning. A recognition model specialized for each compression degree is generated by the augmentation pattern for each compression degree. At the time of recognition, a recognition model is dynamically selected in accordance with a bit rate of a video that fluctuates through the communication. It can be assumed that each recognition model has high accuracy near each bit rate region used in the augmentation. Therefore, the recognition accuracy can be improved by generating and selecting the recognition model according to the present example embodiment.

### Second Example Embodiment

Next, a second example embodiment will be described. In the present example embodiment, an example will be described in which a recognition model is generated and selected on the basis of a frame rate of a video. The configuration and operation of the present example embodiment are basically obtained by replacing the bit rate in the configuration and operation of the first example embodiment with the frame rate. Hereinafter, the configuration and operations different from those of the first example embodiment will be mainly described.

### <Configuration at Time of Learning>

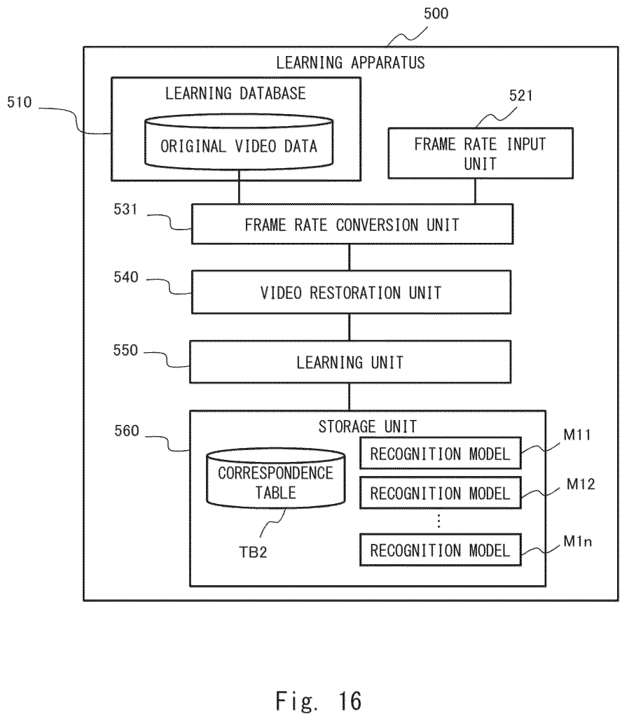

FIG. 16 illustrates a configuration example of the learning apparatus according to the present example embodiment. As illustrated in FIG. 16, the learning apparatus 500 according to the present example embodiment includes a frame rate input unit 521 and a frame rate conversion unit 531 instead of the bit rate input unit 520 and the compressed data generation unit 530 in the first example embodiment.

The frame rate input unit 521 inputs a frame rate of a video to be learned by the recognition model. As in the first example embodiment, without being limited to the frame rate, a frame rate range may be used. The frame rate range indicates a width of the frame rate, such as a first frame rate to a second frame rate. For example, the frame rate range may be 30 fps to 10 fps or may be 10 fps to 3 fps. The frame rate conversion unit 531 converts the frame rate of the original video data stored in the learning database 510 into the input frame rate. For example, in a case where the input frame rate is higher than that of the original video data, the frame rate conversion unit 531 duplicates the frames in the video at predetermined intervals such that the frame rate becomes the designated rate. In addition, for example, in a case where the input frame rate is lower than that of the original video data, the frame rate conversion unit 531 deletes the frames in the video at predetermined intervals such that the frame rate becomes the designated rate. As in the first example embodiment, the frame rate conversion unit 531 may compress the original video data to generate the compressed data. In addition, as in the first example embodiment, the video restoration unit 540 may restore the original video data from the generated compressed data. Note that, in a case where the original video data is not compressed, the video restoration unit 540 may not be provided.

In addition, the learning unit 550 performs machine learning for each input frame rate, and generates the recognition models M11 to M1n that have learned videos for each frame rate. The storage unit 560 stores the generated recognition models M11 to M1n, and stores a correspondence table TB2 in which the frame rate of the learned video is associated with the recognition model.

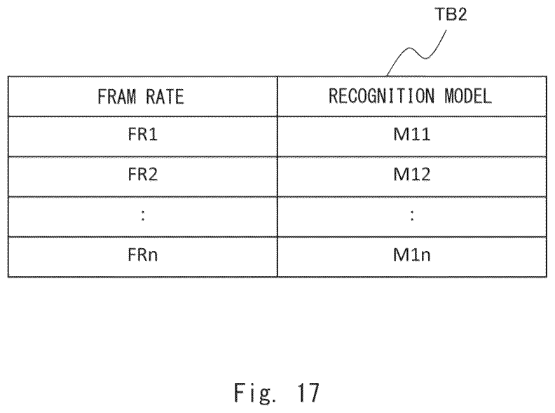

FIG. 17 illustrates a specific example of the correspondence table TB2. With the correspondence table TB2 in which the frame rate and the recognition model are associated, it is possible to select a recognition model for recognizing a video according to a frame rate of the video. In this example, a frame rate FR1 and the recognition model M11 are associated, a frame rate FR2 and the recognition model M12 are associated, . . . , and a frame rate FRn and the recognition model M1n are associated. That is, the recognition model M11 learns the video at the frame rate FR1, the recognition model M12 learns the video at the frame rate FR2, . . . , and the recognition model M1n learns the video at the frame rate FRn. The frame rates FR1 to FRn are different frame rates, and have, for example, a relationship of FR1>FR2> . . . >FRn, but are not limited thereto. As in the first example embodiment, the frame rates FR1 to FRn may be frame rate ranges each having a width. For example, the frame rate FR1 may be 30 fps to 10 fps, and the frame rate FR2 may be 10 fps to 3 fps.

### <Configuration at Time of Recognition>

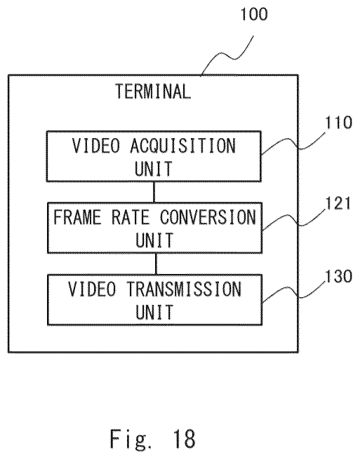

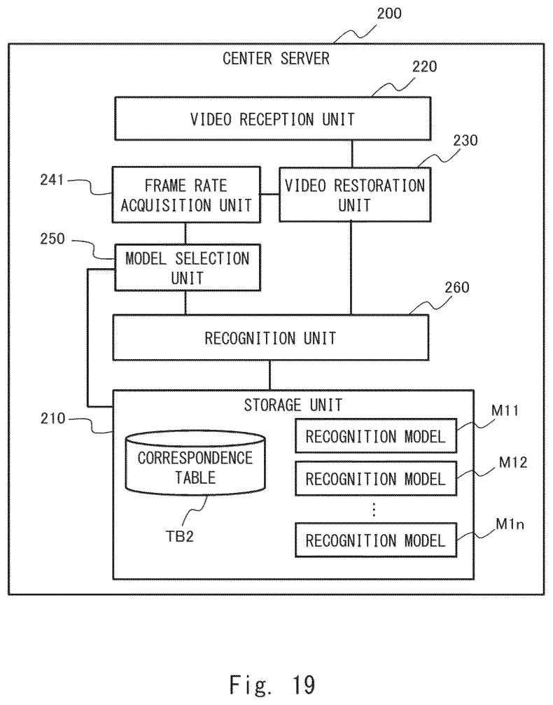

FIG. 18 illustrates a configuration example of the terminal 100 according to the present example embodiment, and FIG. 19 illustrates a configuration example of the center server 200 according to the present example embodiment.

As illustrated in FIG. 18, the terminal 100 according to the present example embodiment includes a frame rate conversion unit 121 instead of the video compression unit 120 in the first example embodiment. The frame rate conversion unit 121 converts the frame rate of the acquired input video into a predetermined frame rate. A specific conversion method of the frame rate may be similar to that of the frame rate conversion unit 531. As in the first example embodiment, the frame rate conversion unit 121 may compress the input video to generate the compressed video.

As illustrated in FIG. 19, the center server 200 according to the present example embodiment includes a frame rate acquisition unit 241 instead of the bit rate acquisition unit 240 in the first example embodiment. The frame rate acquisition unit 241 acquires the frame rate of the received video. For example, the frame rate acquisition unit 241 acquires the frame rate included in the header of the compressed video received by the video reception unit 220. Not only the header of the compressed video but also a packet including the compressed video and the frame rate may be transmitted from terminal 100 to the video reception unit 220, and the frame rate acquisition unit 241 may acquire the frame rate from the received packet. In addition, the storage unit 210 stores the recognition models M11 to M1n generated by the learning apparatus 500 and the correspondence table TB2. Note that the description of units that operate similarly to FIG. 10 in the first example embodiment is omitted.

### <Operation at Time of Learning>

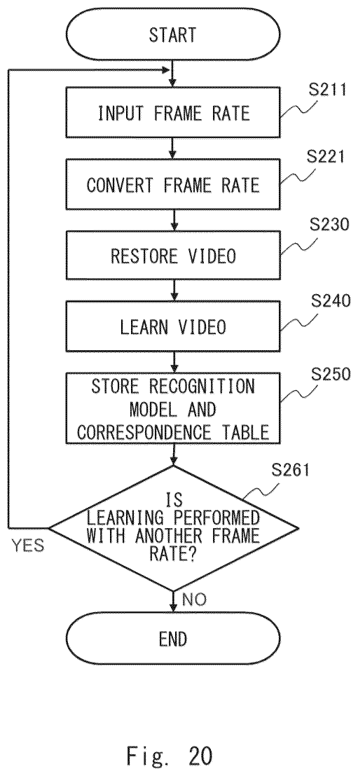

FIG. 20 illustrates an operation example of the learning apparatus 500 according to the present example embodiment. As illustrated in FIG. 20, the learning apparatus 500 inputs the frame rate (S211), and converts the frame rate of the original video data (S221). For example, the frame rate of the video that the user causes the recognition model to learn is input via the frame rate input unit 521, and the frame rate conversion unit 531 converts the frame rate of the original video data into the input frame rate. The frame rate conversion unit 531 generates the compressed data obtained by compressing the original video data by encoding the original video data at the input frame rate and a predetermined bit rate.

Subsequently, the learning apparatus 500 restores the original video data (S230), and learns the restored data (S240). The video restoration unit 540 generates decoded restoration data by decoding the compressed data compressed at the input frame rate and a predetermined bit rate. The learning unit 550 performs machine learning using the generated restoration data, and generates a trained recognition model that has learned the video of the input frame rate.

Subsequently, the learning apparatus 500 stores the generated recognition model and correspondence table (S250). The storage unit 560 stores the generated recognition model, and stores the correspondence table TB2 in which the frame rate of the learned video is associated with the recognition model. As in the first example embodiment, in the correspondence table TB2, information of the learned image or video, the type or name of the recognition target, and the like may be stored in association with each other.

Subsequently, the learning apparatus 500 determines whether or not to perform learning with another frame rate (S261). In a case of performing learning with another frame rate, learning is performed by repeating S211 and subsequent steps, and in a case of not performing learning with another bit rate, the processing is ended.

Note that, in the input of the frame rate (S211), only one frame rate may be designated, or a plurality of frame rates may be designated. In a case where a plurality of frame rates is designated, one piece of original video data may be converted at the plurality of designated frame rates, and learning may be performed using the video data of different frame rates after conversion. In addition, one piece of original video data may be divided into a plurality of pieces, the divided pieces of division video data may be converted at different frame rates, and learning may be performed using the division video data at different frame rates after conversion. For example, the original video data may be divided into first division video data and second division video data, the first division video data may be converted at the first frame rate, the second division video data may be converted at the second frame rate, and the learning may be performed using the converted division video data. When the video data is divided, the division may be performed temporally, or may be performed regionally, that is, spatially. For example, in the case of performing the division temporally, the video data may be divided for each predetermined time. In this case, the division video data at different frame rates may be generated by changing the number of frames per unit time for each predetermined time. For example, in the case of performing the division spatially, each frame of the video data may be divided for each region. In this case, the division video data at substantially different frame rates may be generated by changing the number of times of changing the image per unit time for each predetermined region of the frame.

### <Operation at Time of Recognition>

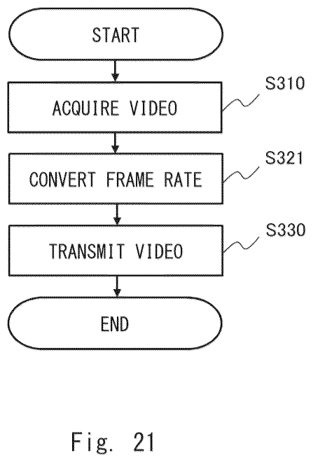

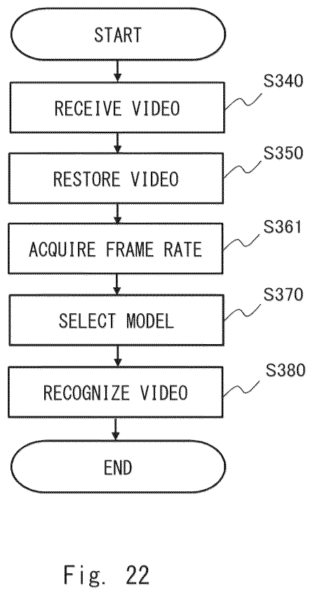

FIG. 21 illustrates an operation example of the terminal 100 according to the present example embodiment, and FIG. 22 illustrates an operation example of the center server 200 according to the present example embodiment.

As illustrated in FIG. 21, the terminal 100 acquires the video from the camera 101 (S310), converts the frame rate of the acquired input video (S321), and transmits the converted compressed video to the center server 200 (S330). The frame rate conversion unit 121 encodes the input video by a predetermined video encoding system, and generates the compressed video obtained by converting and compressing the frame rate of the input video. For example, the frame rate conversion unit 121 may encode the input video by setting the frame rate so as to obtain the bit rate allocated from the compression bit rate control function 401 of the MEC 400, or may encode the input video by setting the frame rate to obtain the bit rate according to the communication quality between the terminal 100 and the center server 200.

Subsequently, as illustrated in FIG. 22, the center server 200 receives the compressed video from the terminal 100 (S340), generates the received video obtained by restoring the original video from the compressed video (S350), and acquires the frame rate of the received video (S361). The video restoration unit 230 decodes the compressed video on the basis of the frame rate or the bit rate of the compressed video, and generates the decoded video. The frame rate acquisition unit 241 acquires the frame rate included in the header of the compressed video received by the video reception unit 220.

Subsequently, the center server 200 selects a recognition model for analyzing the received video (S370), and performs video recognition on the received video by using the selected recognition model (S380). The model selection unit 250 selects a recognition model for analyzing the received video, according to the frame rate of the received video. The model selection unit 250 determines a recognition model corresponding to the frame rate of the received video by referring to the table TB2 of the storage unit 210. In the example of the correspondence table TB2 of FIG. 17, in a case where the frame rate of the received video is the frame rate FR1, the recognition model M11 is selected as the recognition model for analyzing the received video.

As described above, in the second example embodiment, the recognition model may be generated and selected on the basis of the frame rate of the video. That is, in the present example embodiment, a plurality of recognition models that has learned the videos having different frame rates at the time of learning are generated, and the recognition model is selected according to the frame rate of the video at the time of recognition. In a case where the frame rates of the video data at the time of learning and at the time of recognition are close to each other, the recognition accuracy is high, and in a case where the frame rates are different from each other, the recognition accuracy tends to be decreased. However, the recognition accuracy can be improved by generating and selecting the recognition model according to the present example embodiment.

### Third Example Embodiment

Next, a third example embodiment will be described. In the present example embodiment, an example will be described in which, in a case where a recognition model is selected on the basis of a frame rate of a video, the recognition model is selected on the basis of an increase/decrease tendency of the frame rate. Hereinafter, an operation of the center server will be mainly described as an operation different from the second example embodiment. Note that other configurations and operations are similar to those of the second example embodiment.

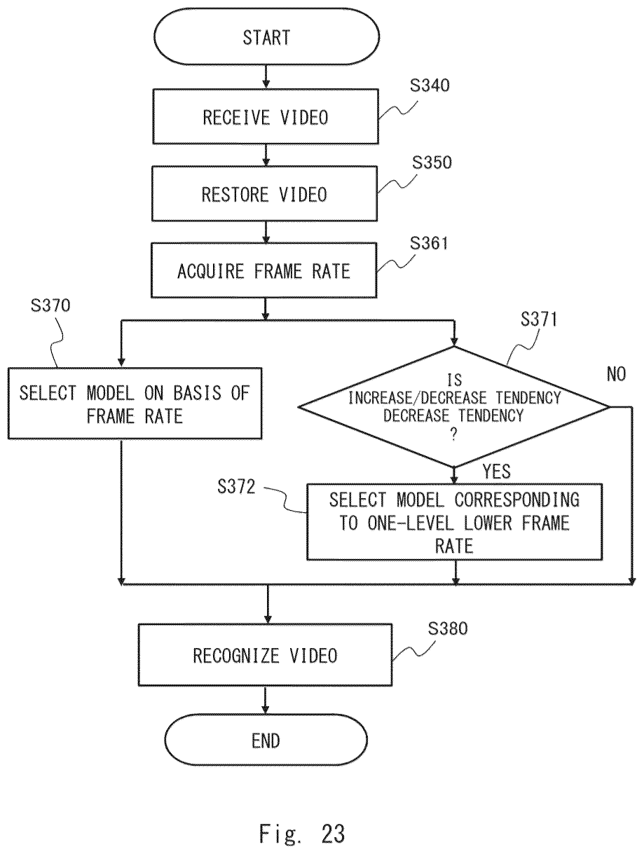

FIG. 23 illustrates an operation example of the center server 200 according to the present example embodiment. As illustrated in FIG. 23, as in the second example embodiment, the center server 200 receives the compressed video from the terminal 100 (S340), generates the received video obtained by restoring the original video (S350), and acquires the frame rate of the received video (S361).

Subsequently, the center server 200 selects a recognition model on the basis of the latest trend of the frame rate, that is, the increase/decrease tendency (S370 to S372). The frame rate conversion unit 121 of the terminal 100 may determine the increase/decrease tendency from the converted frame rate, and notify the center server 200 of the determined increase/decrease tendency by embedding the determined increase/decrease tendency in the video data. In addition, the increase/decrease tendency may be determined from the frame rate acquired by the frame rate acquisition unit 241 of the center server 200. For example, the increase/decrease tendency of the frame rate can be extracted on the basis of the history of the past frame rates acquired periodically.

As in the second example embodiment, the model selection unit 250 selects a recognition model on the basis of the frame rate (S370), and determines whether or not an increase/decrease tendency of the frame rate is a decrease tendency (S371). In a case where the increase/decrease tendency of the frame rate is a decrease tendency, a recognition model corresponding to the one-level lower frame rate is selected (S372). In a case where the frame rate is not on a decrease tendency, the selection of the recognition model according to the increase/decrease tendency is not performed. In a case where the frame rate is on the decrease tendency, since it is expected that the recognition model is switched after several frames, a recognition model corresponding to a one-level lower frame rate is selected as a recognition model to be selected next by decreasing the frame rate, that is, a recognition model as the switching destination to be switched to next.

The one-level lower frame rate is a frame rate used in learning, that is, a frame rate lower by one than the frame rate corresponding to the currently selected recognition model among the frame rates associated in the correspondence table TB2, and is a frame rate adjacent to a low frame rate side of the frame rate corresponding to the currently selected recognition model. For example, when the frame rates FR1 to FR3 are defined in the correspondence table TB2 and there is a relationship of FR1>FR2>FR3, in a case where the frame rate of the currently selected recognition model is the frame rate FR1, the one-level lower frame rate is the frame rate FR2. In addition, the model selection unit 250 may change, that is, adjust the frame rate of the video to be input, according to the frame rate of the recognition model corresponding to the one-level lower frame rate selected at this time. Although a method of adjusting the frame rate is not limited, for example, the frames may be thinned out according to the frame rate corresponding to the recognition model. The recognition unit 260 recognizes the video by using one or two recognition models selected in S370 and S380 (S380). Note that the operation is not limited to the example of FIG. 23, and may be performed similarly in a case where the frame rate is on the increase tendency. For example, in a case where the frame rate is on the increase tendency, a recognition model corresponding to the one-level higher frame rate may be selected.

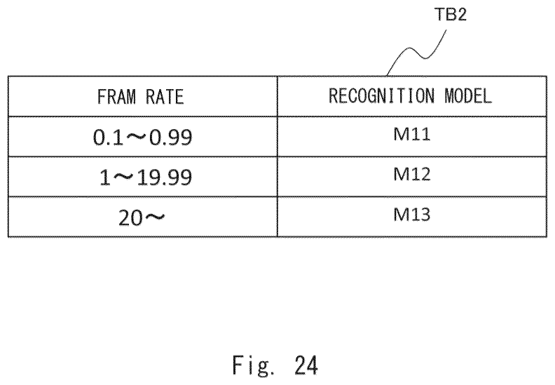

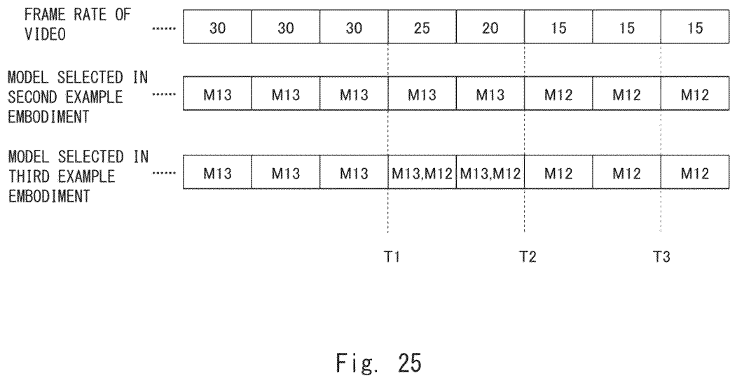

A specific example of the operation according to the present example embodiment will be described with reference to FIGS. 24 and 25. FIG. 24 illustrates an example of the correspondence table TB2. In the example of FIG. 24, a frame rate of 0.1 fps to 0.99 fps and the recognition model M11 are associated, a frame rate of 1 fps to 19.99 fps and the recognition model M12 are associated, and a frame rate of 20 fps or more and the recognition model M13 are associated.

FIG. 25 illustrates an example of selecting the recognition model according to the frame rate of the video using the correspondence table TB2 of FIG. 24. In the example of FIG. 25, it is assumed that the frame rate of the video is changed in the order of 30 fps, 25 fps, 20 fps, and 15 fps. When the recognition model is selected by the method of the second example embodiment, the recognition model M13 is selected until the frame rate is 30 fps to 20 fps, and the recognition model is switched to the recognition model M12 at timing T2 when the frame rate is decreased to 15 fps. That is, T2 is the switching timing. For example, assuming that each recognition model can output the recognition result from the third frame after the frame is input, the recognition model M12 can output the recognition result for the first time at timing T3.

Therefore, in the present example embodiment, in a case where the frame rate in the decrease tendency, from the timing before switching the recognition model, the recognition model M12 as the switching destination to be switched to next is selected and the input of the video is started. As a result, the recognition model M12 that may be selected after several frames can be brought into a ready state in advance, that is, a state in which the recognition result can be output. The recognition model M12 is a recognition model corresponding to a frame rate lower by one level than the currently selected recognition model M13. By inputting the video to the recognition model M12 from the timing T1 three frames before the switching timing T2, the recognition result can be output from the recognition model M12 at the switching timing T2. From the timing T1 to the timing T2, the recognition model M13 corresponding to the current frame rate and the recognition model M12 corresponding to the one-level lower frame rate are selected, and the video is input to both the recognition models. In addition, the frame rate from the timing T1 to the timing T2 is higher than the frame rate of 1 to 19.99 corresponding to the recognition model M12. For this reason, the video obtained by thinning out the frames so that the frame rate becomes 1 to 19.99 is input to the recognition model M12. Note that even in a case where frames are input and the recognition result can be output from the first frame, at the timing when the frame rate is changed, a result with a higher score of the recognition result can be used by using the two recognition models. This case is particularly effective in a case where the learned frame of the recognition model has no width.

As described above, in the second example embodiment, in a case where the frame rate of the video is on the decrease tendency, the video may be input to the recognition model corresponding to the one-level lower frame rate. As a result, it is possible to input a video in advance to a recognition model expected to be switched to and output a recognition result from the switching timing. In addition, by inputting a video obtained by thinning out frames, to the recognition model corresponding to the one-level lower frame rate, a video suitable for the recognition model can be input, and the recognition accuracy can be improved.

### Fourth Example Embodiment

Next, a fourth example embodiment will be described. In the present example embodiment, an example of selecting a recognition model on the basis of an actually measured image quality will be described. Hereinafter, configurations of the terminal and the center server will be mainly described as the configurations different from those of the first example embodiment. Note that other configurations and operations are similar to those of the first example embodiment.

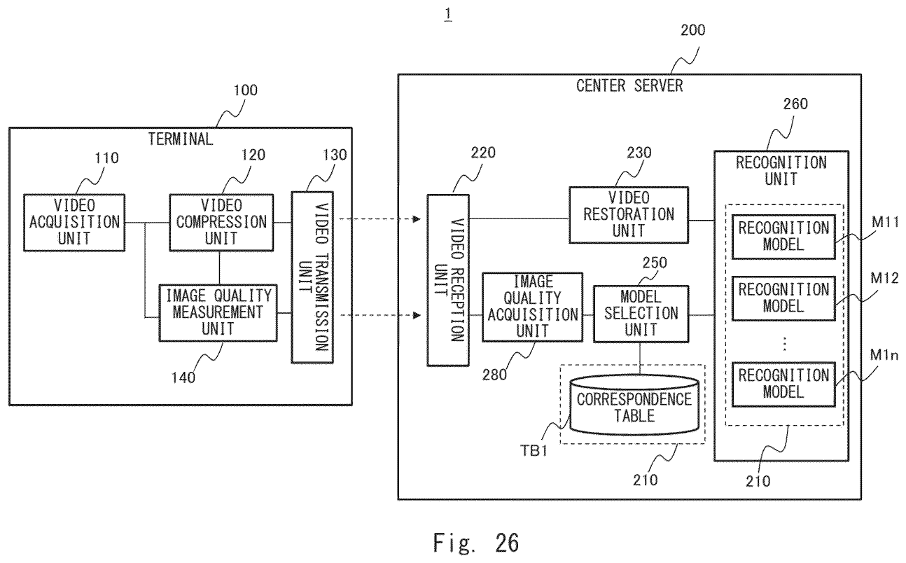

FIG. 26 illustrates a configuration example of the remote monitoring system 1 according to the present example embodiment. As illustrated in FIG. 26, the terminal 100 according to the present example embodiment includes an image quality measurement unit 140 in addition to the configuration of the first example embodiment.

The image quality measurement unit 140 measures the image quality of the compressed video compressed by the video compression unit 120. The image quality measurement unit 140 compares the input video acquired by the video acquisition unit 110, that is, the video before the compression with the compressed video compressed by the video compression unit 120, and obtains an image quality index indicating the image quality of the compressed video. The image measurement unit 140 measures an image quality index on the basis of a difference between the image before the image quality change and the image after the image quality change in the image of which the image quality is changed by the compression. For example, the image quality measurement unit 140 obtains the image quality index for each image of the video, that is, for each frame. The image quality index is, for example, MS-SSIM or PSNR, but is not limited thereto, and may be SSIM, SNR, mean squared error (MSE), or the like. The image quality index may be an index indicating the image quality of the entire image or an index indicating the image quality of each block or region obtained by subdividing the image. For example, an image quality index for each 64×64 pixel blocks or an image quality index for each 16×16 pixel blocks may be used. The image quality index may be the image quality index of the object region as in the first example embodiment.

The video transmission unit 130 transmits the compressed video compressed by the video compression unit 120 and the image quality index measured by the image quality measurement unit 140 to the center server 200. For example, the video transmission unit 130 may include the image quality index in the packet including the compressed video and transmit the packet.

In addition, the center server 200 according to the present example embodiment includes an image quality acquisition unit 280 in addition to the configuration of the first example embodiment. The image quality acquisition unit 280 acquires the image quality of the compressed video measured by the terminal 100. The video reception unit 220 receives the compressed video and the image quality index from the terminal 100, and the image quality acquisition unit 280 acquires the received image quality index.

The model selection unit 250 selects a recognition model for analyzing the received video, on the basis of the acquired image quality. The recognition model may be a model that has learned videos having different bit rates as in the first example embodiment, or may be a model that has learned videos having different image quality indexes. In a case where videos having different image quality indexes are learned, similarly to the image quality measurement unit 140, an image quality index is obtained from the video before the compression and the video after the compression, and a recognition model that has learned the video for each obtained image quality index is generated.

For example, in a case where the correspondence table TB1 in which the bit rate and the recognition model are associated is used, the image quality index may be further associated with the recognition model. In the correspondence table TB1, instead of the bit rate, the image quality index may be associated with the recognition model. As in the first example embodiment, the range of the image quality index may be associated with the recognition model. The model selection unit 250 selects a recognition model corresponding to the acquired image quality index by referring to the correspondence table TB1. In a case where the image quality index is obtained for each block, a recognition model corresponding to the image quality index may be selected for each block.

As described above, in the first example embodiment, the recognition model may be selected on the basis of the actually measured image quality. The recognition accuracy of the recognition model may be greatly affected by the fluctuation in the actual image quality. Therefore, by selecting a recognition model on the basis of the image quality actually measured from the image before the compression and the image after the compression, it is possible to further select an optimal recognition model and to improve the recognition accuracy. Note that the present example embodiment may be applied to the second and third example embodiments.

Note that the present disclosure is not limited to the above-described example embodiments, and can be appropriately modified without departing from the scope.

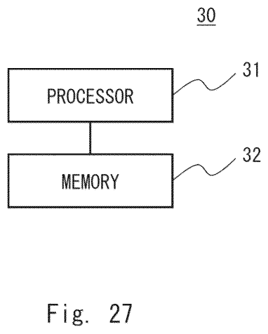

Each configuration in the above-described example embodiments may be implemented by hardware, software, or both, and may be implemented by one piece of hardware or software or by a plurality of pieces of hardware or software. The apparatuses and functions (processing) may be realized by a computer 30 including a processor 31, such as a central processing unit (CPU), and a memory 32, which is a storage device, as illustrated in FIG. 27. For example, programs for performing the methods (video processing methods) in the example embodiments may be stored in the memory 32, and the functions may be realized by the processor 31 executing the programs stored in the memory 32.

These programs include a group of commands (or software codes) causing a computer to perform one or more of the functions described in the example embodiments in a case of being read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer-readable medium or a communication medium. By way of example, and not limitation, transitory computer-readable or communication media include electrical, optical, acoustic, or other forms of propagated signals.

Although the present disclosure has been described above with reference to the example embodiments, the present disclosure is not limited to the above-described example embodiments. Various modifications that can be understood by those skilled in the art can be made to the configurations and details of the present disclosure within the scope of the present disclosure.

Some or all of the above-described example embodiments may be described as in the following Supplementary Notes, but are not limited to the following Supplementary Notes.

### Supplementary Note 1

A video processing system comprising:
a plurality of recognition models that has learned video learning data corresponding to different video quality parameters, for each of the video quality parameters; and
selection means for selecting a recognition model that performs recognition regarding a target included in video input data to be input, according to a video quality parameter of the video input data.

### Supplementary Note 2

The video processing system according to Supplementary Note 1, wherein
the plurality of recognition models learns the video learning data for each range of the video quality parameters, and
the selection means selects the recognition model on the basis of the range corresponding to the video quality parameter of the video input data.

### Supplementary Note 3

The video processing system according to Supplementary Note 1 or 2, wherein the selection means selects the recognition model for each region of the video input data on the basis of the video quality parameter of each region of the video input data.

### Supplementary Note 4

The video processing system according to Supplementary Note 3, further comprising object detection means for detecting an object included in the video input data,
wherein the region is a region including the object detected by the object detection means.

### Supplementary Note 5

The video processing system according to any one of Supplementary Notes 1 to 4, wherein
the video quality parameter includes a frame rate, and
the selection means selects the recognition model on the basis of an increase/decrease tendency of the frame rate of the video input data.

### Supplementary Note 6

The video processing system according to Supplementary Note 5, wherein the selection means changes the frame rate of the video input data according to the selected recognition model.

### Supplementary Note 7

The video processing system according to any one of Supplementary Notes 1 to 6, wherein
the video input data includes an image of which an image quality is changed, and
the video quality parameter includes an image quality index based on a difference between an image before an image quality change and an image after the image quality change.

### Supplementary Note 8

A video processing apparatus comprising:
a plurality of recognition models that has learned video learning data corresponding to different video quality parameters, for each of the video quality parameters; and
selection means for selecting a recognition model that performs recognition regarding a target included in video input data to be input, according to a video quality parameter of the video input data.

### Supplementary Note 9

The video processing apparatus according to Supplementary Note 8, wherein
the plurality of recognition models learns the video learning data for each range of the video quality parameters, and
the selection means selects the recognition model on the basis of the range corresponding to the video quality parameter of the video input data.

### Supplementary Note 10

The video processing apparatus according to Supplementary Note 8 or 9, wherein the selection means selects the recognition model for each region of the video input data on the basis of the video quality parameter of each region of the video input data.

### Supplementary Note 11

The video processing apparatus according to Supplementary Note 10, further comprising object detection means for detecting an object included in the video input data,
wherein the region is a region including the object detected by the object detection means.

### Supplementary Note 12

The video processing apparatus according to any one of Supplementary Notes 8 to 11, wherein
the video quality parameter includes a frame rate, and
the selection means selects the recognition model on the basis of an increase/decrease tendency of the frame rate of the video input data.

### Supplementary Note 13

The video processing apparatus according to Supplementary Note 12, wherein the selection means changes the frame rate of the video input data according to the selected recognition model.

### Supplementary Note 14

The video processing apparatus according to any one of Supplementary Notes 8 to 13, wherein
the video input data includes an image of which an image quality is changed, and
the video quality parameter includes an image quality index based on a difference between an image before an image quality change and an image after the image quality change.

### Supplementary Note 15

A video processing method comprising:
acquiring video input data; and
selecting a recognition model that performs recognition regarding a target included in the video input data, according to a video quality parameter of the video input data, from a plurality of recognition models that has learned video learning data corresponding to different video quality parameters, for each of the video quality parameters.

### Supplementary Note 16

The video processing method according to Supplementary Note 15, wherein
the plurality of recognition models is recognition models that have learned the video learning data for each range of the video quality parameters, and
the recognition model is selected on the basis of the range corresponding to the video quality parameter of the video input data.

### Supplementary Note 17

The video processing method according to Supplementary Note 15 or 16, wherein the recognition model is selected for each region of the video input data on the basis of the video quality parameter of each region of the video input data.

### Supplementary Note 18

The video processing method according to Supplementary Note 17, further comprising detecting an object included in the video input data, wherein the region is a region including the detected object.

### Supplementary Note 19

The video processing method according to any one of Supplementary Notes 15 to 18, wherein
the video quality parameter includes a frame rate, and
the recognition model is selected on the basis of an increase/decrease tendency of the frame rate of the video input data.

### Supplementary Note 20

The video processing method according to Supplementary Note 19, wherein the frame rate of the video input data is changed according to the selected recognition model.

### Supplementary Note 21

The video processing method according to any one of Supplementary Notes 15 to 20, wherein
the video input data includes an image of which an image quality is changed, and
the video quality parameter includes an image quality index based on a difference between an image before an image quality change and an image after the image quality change.

### Supplementary Note 22

A video processing program causing a computer to execute processing including:
acquiring video input data; and
selecting a recognition model that performs recognition regarding a target included in the video input data, according to a video quality parameter of the video input data, from a plurality of recognition models that has learned video learning data corresponding to different video quality parameters, for each of the video quality parameters.

### REFERENCE SIGNS LIST

1 REMOTE MONITORING SYSTEM
10 VIDEO PROCESSING SYSTEM
11 SELECTION UNIT
20, 21, 22 VIDEO PROCESSING APPARATUS
30 COMPUTER
31 PROCESSOR
32 MEMORY
100 TERMINAL
101 CAMERA
102 COMPRESSION EFFICIENCY OPTIMIZATION FUNCTION
110 VIDEO ACQUISITION UNIT
120 VIDEO COMPRESSION UNIT
121 FRAME RATE CONVERSION UNIT
130 VIDEO TRANSMISSION UNIT
140 IMAGE QUALITY MEASUREMENT UNIT
200 CENTER SERVER
201 VIDEO RECOGNITION FUNCTION
202 ALERT GENERATION FUNCTION
203 GUI DRAWING FUNCTION
204 SCREEN DISPLAY FUNCTION
210 STORAGE UNIT
220 VIDEO RECEPTION UNIT
230 VIDEO RESTORATION UNIT
240 BIT RATE ACQUISITION UNIT
241 FRAME RATE ACQUISITION UNIT
250 MODEL SELECTION UNIT
260 RECOGNITION UNIT
270 OBJECT DETECTION UNIT
280 IMAGE QUALITY ACQUISITION UNIT
300 BASE STATION
401 COMPRESSION BIT RATE CONTROL FUNCTION
500 LEARNING APPARATUS
510 LEARNING DATABASE
520 BIT RATE INPUT UNIT
521 FRAME RATE INPUT UNIT
530 COMPRESSED DATA GENERATION UNIT
531 FRAME RATE CONVERSION UNIT
540 VIDEO RESTORATION UNIT
550 LEARNING UNIT
560 STORAGE UNIT
M1 to M4, M11 to M1n RECOGNITION MODEL
TB1, TB2 CORRESPONDENCE TABLE

What is claimed is:

1. A video processing system comprising:
a plurality of recognition models that has learned video learning data corresponding to different video quality parameters, for each of the video quality parameters;
a memory configured to store instructions; and
a processor configured to execute the instructions to select a recognition model that performs recognition regarding a target included in video input data to be input, according to a video quality parameter of the video input data.

2. The video processing system according to claim 1, wherein
the plurality of recognition models learns the video learning data for each range of the video quality parameters, and
the processor is further configured to execute the instructions to select the recognition model on the basis of the range corresponding to the video quality parameter of the video input data.

3. The video processing system according to claim 1, wherein the processor is further configured to execute the instructions to select the recognition model for each region of the video input data on the basis of the video quality parameter of each region of the video input data.

4. The video processing system according to claim 3, wherein the processor is further configured to execute the instructions to detect an object included in the video input data, and
the region is a region including the object detected by the object detection means.

5. The video processing system according to claim 1, wherein
the video quality parameter includes a frame rate, and
the processor is further configured to execute the instructions to select the recognition model on the basis of an increase/decrease tendency of the frame rate of the video input data.

6. The video processing system according to claim 5, wherein the processor is further configured to execute the instructions to change the frame rate of the video input data according to the selected recognition model.

7. The video processing system according claim 1, wherein
the video input data includes an image of which an image quality is changed, and
the video quality parameter includes an image quality index based on a difference between an image before an image quality change and an image after the image quality change.

8. A video processing apparatus comprising:
a plurality of recognition models that has learned video learning data corresponding to different video quality parameters, for each of the video quality parameters; and
a memory configured to store instructions; and
a processor configured to execute the instructions to select a recognition model that performs recognition regarding a target included in video input data to be input, according to a video quality parameter of the video input data.

9. The video processing apparatus according to claim 8, wherein
the plurality of recognition models learns the video learning data for each range of the video quality parameters, and
the processor is further configured to execute the instructions to select the recognition model on the basis of the range corresponding to the video quality parameter of the video input data.

10. The video processing apparatus according to claim 8, wherein the processor is further configured to execute the instructions to select the recognition model for each region of the video input data on the basis of the video quality parameter of each region of the video input data.

11. The video processing apparatus according to claim 10, wherein the processor is further configured to execute the instructions to detect an object included in the video input data, and
the region is a region including the object detected by the object detection means.

12. The video processing apparatus according to claim 8, wherein
the video quality parameter includes a frame rate, and
the processor is further configured to execute the instructions to select the recognition model on the basis of an increase/decrease tendency of the frame rate of the video input data.

13. The video processing apparatus according to claim 12, wherein the processor is further configured to execute the instructions to change the frame rate of the video input data according to the selected recognition model.

14. The video processing apparatus according to claim 8, wherein
the video input data includes an image of which an image quality is changed, and
the video quality parameter includes an image quality index based on a difference between an image before an image quality change and an image after the image quality change.

15. A video processing method comprising:
acquiring video input data; and
selecting a recognition model that performs recognition regarding a target included in the video input data, according to a video quality parameter of the video input data, from a plurality of recognition models that has learned video learning data corresponding to different video quality parameters, for each of the video quality parameters.

16. The video processing method according to claim 15, wherein
the plurality of recognition models is recognition models that have learned the video learning data for each range of the video quality parameters, and
the recognition model is selected on the basis of the range corresponding to the video quality parameter of the video input data.

17. The video processing method according to claim 15, wherein the recognition model is selected for each region of the video input data on the basis of the video quality parameter of each region of the video input data.

18. The video processing method according to claim 17, further comprising detecting an object included in the video input data, wherein the region is a region including the detected object.

19. The video processing method according to claim 15, wherein
the video quality parameter includes a frame rate, and
the recognition model is selected on the basis of an increase/decrease tendency of the frame rate of the video input data.

20. The video processing method according to claim 19, wherein the frame rate of the video input data is changed according to the selected recognition model.

21. (canceled)
